(19) United States
(12) Patent Application Publication
(10) Pub. No.: US 2007/0018012 A1
(43) Pub. Date: Jan. 25, 2007

(54) Nozzle and method of making the same

(76) Inventors: Daryl G. Harris, Oxford, MI (US); Yaomin Dong, Rochester Hills, MI (US); Oksana M. Kiseleva, Rochester Hills, MI (US); Uwe Lasebnick, Ditzingen (DE)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/184,441

(22) Filed: Jul. 19, 2005

(51) Int. Cl. B05B 1/10

(52) U.S. Cl. 239/284.1; 15/250.4

(57) ABSTRACT

A method for forming an embodiment of a fluid nozzle assembly includes removing two cores in opposed directions from a die set having a mold cavity configured to be a negative replica of the fluid nozzle assembly. The cavity includes the two cores, with one core configured to be a negative replica of: a fluid connector receiving bore; an inlet region of a nozzle; and a pass-through conduit, each in fluid communication with the fluid connector receiving bore. The other core is configured to be a negative replica of an outlet region of a nozzle in fluid communication with the inlet region. Removing the cores forms the nozzle assembly after molten polymeric material injected into the mold cavity has solidified. Removing leaves substantially no flash: at an area where the inlet region and the outlet region meet; and at an end region of the pass-through conduit distal to the receiving bore.

### BACKGROUND

The present disclosure relates generally to fluid nozzles, and more particularly to fluid nozzle assemblies.

Some vehicle windshield washing systems may include two or more wiper arm-mounted fluid spray nozzles. Attachment to the wiper arms may be an alternative to nozzles mounted on stationary components of the vehicle. The first nozzle is typically a pass-through design, where the fluid supply conduit is connected to the first nozzle, and a second fluid conduit is connected between the first nozzle and a downstream nozzle. This serial fluid supply reduces the total length of conduit required, and may be a more straightforward system than a parallel fluid supply.

Some current pass-through nozzle designs are quite complex, requiring multiple intersecting cores during an injection molding process. During this molding process, these intersecting cores may undesirably lead to internal flash that is difficult to remove with a reasonable amount of effort, thus potentially resulting in rejected parts, or defective parts that inadvertently reach the customer. Flash is excess polymeric material squeezing out perpendicular to the part at a parting line between two cores. If flash restrictions are not substantially contained by the manufacturing process, then flow through the nozzles may not meet design intent in some cases.

As such, it would be desirable to provide a nozzle and method of manufacturing the same that aids in preventing undesirable internal flash within fluid conduits and/or nozzles.

### SUMMARY

The present disclosure provides a fluid nozzle assembly. A method for forming an embodiment of a fluid nozzle assembly is also disclosed, which includes removing two cores in opposed directions from a die set having a mold cavity therein configured to be a negative replica of the fluid nozzle assembly. The cavity includes the two cores, with one core configured to be a negative replica of: a fluid connector receiving bore; an inlet region of a nozzle; and a pass-through conduit, each in fluid communication with the fluid connector receiving bore. The other core is configured to be a negative replica of an outlet region of a nozzle in fluid communication with the inlet region. Removing the cores forms the nozzle assembly after molten polymeric material injected into the mold cavity has solidified. This removing leaves substantially no flash: at an area where the inlet region and the outlet region meet; and at an end region of the pass-through conduit distal to the receiving bore.

### BRIEF DESCRIPTION OF THE DRAWINGS

Features and advantages of the present disclosure will become apparent by reference to the following detailed description and drawings, in which like reference numerals correspond to similar, though not necessarily identical components. For the sake of brevity, reference numerals or features having a previously described function may not necessarily be described in connection with other drawings in which they appear.

FIG. 1A is a cross-sectional side view of an embodiment of a die set cavity, showing two cores and an embodiment of the fluid nozzle assembly within the die set cavity;

FIG. 1B is a cross cross-sectional side view of an alternate embodiment of a die set cavity, showing two cores and an alternate embodiment of the fluid nozzle assembly within the die set cavity;

FIG. 1C is a semi-schematic cross-sectional view of an embodiment of a nozzle member receivable within the fluid nozzle assembly formed by the die set of FIG. 1B;

FIG. 2A is a cross-sectional, exploded side view of an embodiment of a fluid nozzle assembly and a fluid connector;

FIG. 2B is a cross-sectional side view showing the fluid connector of FIG. 2A engaged with the fluid nozzle assembly;

FIG. 2C is a cross-sectional side view showing the fluid connector of FIG. 2A engaged with the fluid nozzle assembly formed by the die set of FIG. 1B, and showing the nozzle member of FIG. 1C received therewithin;

FIG. 3 is an exploded isometric view of the embodiment of the fluid nozzle assembly of FIG. 1A, but showing an alternate embodiment of the fluid connector, and the nozzle member of FIG. 1C received within the fluid nozzle assembly;

FIG. 4A is a cross-sectional side view of an alternate embodiment of a nozzle assembly;

FIG. 4B is an isometric view of the embodiment of FIG. 4A;

FIG. 4C is a cutaway, cross-sectional side view showing an alternate embodiment of the nozzle assembly of FIG. 4A;

FIG. 5A is a cutaway perspective view of an embodiment of the fluid nozzle assembly engaged with a fluid connector and retained within a wiper arm;

FIG. 5B is a view similar to that of FIG. 5A, but showing an alternate retaining mechanism;

FIG. 6A is an enlarged, cutaway, cross-sectional view of an embodiment of a rectangular projection received within a slot;

FIG. 6B is a view similar to that of FIG. 6A, but showing an alternate embodiment of a rectangular projection received within a slot;

FIG. 6C is a view similar to that of FIG. 6A, but showing yet a further alternate embodiment of a rectangular projection received within a slot;

FIG. 7A is an isometric view of a further alternate embodiment of a retaining mechanism attached to a nozzle assembly;

FIG. 7B is an enlarged, cross-sectional front view of the embodiment of FIG. 7A, showing the nozzle assembly retained within the wiper arm; and

FIG. 8 is an exploded, cutaway isometric view of a wiper arm assembly with two embodiments of nozzle assemblies.

### DETAILED DESCRIPTION OF THE EMBODIMENTS

It has been unexpectedly and fortuitously discovered that a simplified fluid conduit/nozzle assembly may be formed according to the present disclosure, substantially without undesirable internal flash. The process(es) for forming embodiments of the conduit/assembly of the present disclosure advantageously are cost effective to produce and may result in fewer rejected/defective parts as compared to the current processes mentioned hereinabove.

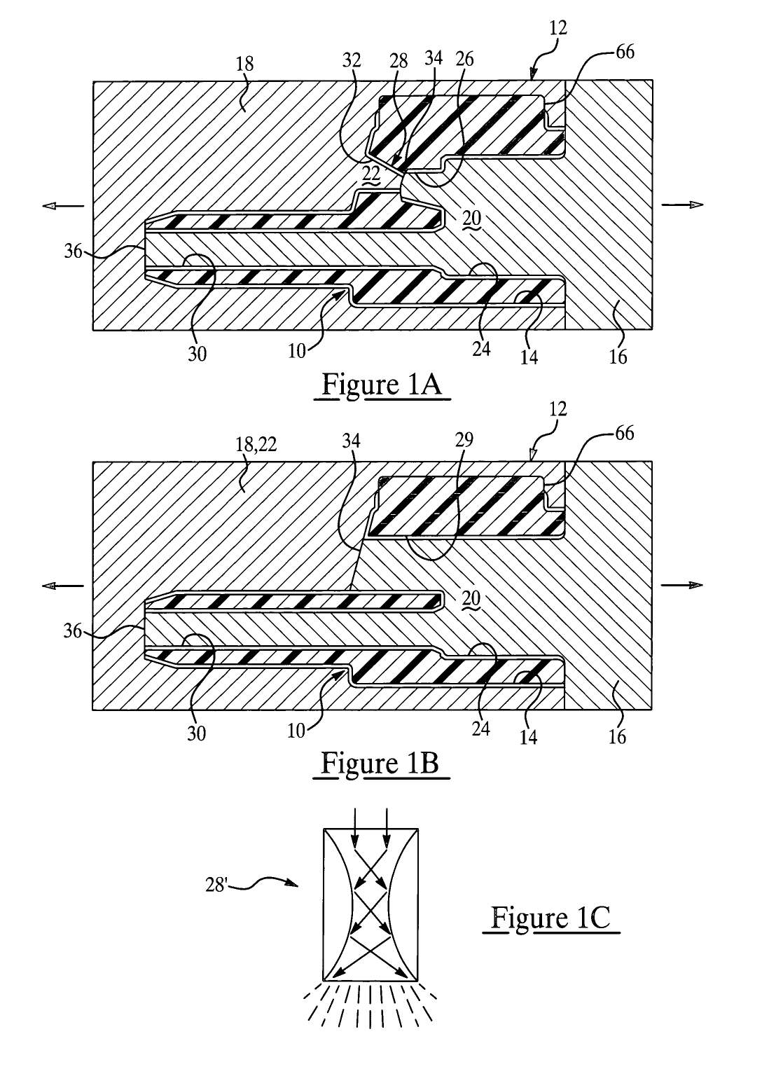

Referring now to FIG. 1, an embodiment of a method for forming a fluid nozzle assembly 10 includes providing a die set 12 having a mold cavity 14 therein configured to be a negative replica of the fluid nozzle assembly 10. Die set 12 includes two dies 16, 18. The cavity 14 has two slide cores 20, 22 operatively disposed therein, the cores 20, 22 being fixed portions of dies 16, 18, respectively, extending furthest inwardly into cavity 14. It is to be understood that the dies 16, 18/cores 20, 22 may be formed from any suitable metal material.

One of the two cores 20, 22 is configured to be a negative replica of: a fluid connector receiving bore 24; an inlet region 26 of a nozzle 28 in fluid communication with the fluid connector receiving bore 24; and a pass-through conduit 30 in fluid communication with the fluid connector receiving bore 24. The other of the two cores 22, 20 is configured to be a negative replica of an outlet region 32 of a nozzle 28 in fluid communication with the inlet region 26. In the non-limitative example shown in FIG. 1, the one core is core 20, and the other core is core 22.

The embodiment of the method further includes injecting the mold cavity 14 with a molten material, and allowing the molten material to solidify. In an embodiment, the molten material is a molten polymeric material. It is to be understood that the polymeric material may be any suitable polymeric material, as desired. In an embodiment, the polymeric material is a thermoplastic material. In a further embodiment, the polymeric material may be at least one of polyamides (nylons), acetals (polyoxymethylene copolymers (POM)), polyethylenes, polyethylene terephthalates (PET), polysulfones, and/or the like, and/or combinations thereof. Depending upon the type of polymeric material used, such solidification may be the result of, for example, cross-linking of the material and/or cooling of the material.

It is to be understood that the present method(s) and assemblies may alternately be formed by metal injection molding (MIM). In such instances, any suitable metal material (for example, powdered metal materials mixed with binders and the like for the molding process) may be used, as desired.

The two cores 20, 22 are then removed from the cavity 14 in opposed directions, as shown by the directional arrows in FIG. 1. This removal of the cores 20, 22 advantageously leaves substantially no flash at an area 34 (a parting line/plane) where the inlet region 26 and the outlet region 32 meet; nor at an end region 36 (another parting line/plane) of the pass-through conduit 30 distal to the fluid connector receiving bore 24. Upon removal of the cores 20, 22, the fluid nozzle assembly 10 is formed.

If flash does occur at either of the two parting lines/planes 34, 36, such flash may be relatively easily removed by any suitable mechanical means and/or prevented in subsequent parts. For example, if flash occurs at parting line/planes 34, 36, flash removal is relatively simple and cost-effective to detect and remove, since the flash would be near the outside of nozzle assembly 10 and not in the middle of a relatively long fluid conduit (in the current designs mentioned in the background hereinabove, the undesirable flash occurred deep within a relatively long (as compared to the rest of the assembly) conduit, and thus was difficult to detect and relatively costly to remove). “Deep” as defined herein is intended to encompass any situation where the flash is in a “blind” area, i.e. an area generally not easily visible to the naked eye. One such non-limitative example of a blind area may be at about the middle of the longitudinal length of the conduit 30, 50 (conduit 50 is described further hereinbelow). Further, it is a relatively simple matter to substantially prevent flash at line/plane 36 through optimization of process parameters, since line/plane 36 is at the exterior opening of pass-through conduit 30. For example, the end of core 20 adjacent line/plane 36 may be sharpened to substantially prevent flash on subsequent parts.

It is to be understood that any suitable configuration of nozzle 28 may be used in conjunction with the present disclosure. Some examples of nozzle 28 include, but are not limited to fan spray nozzles, stream spray nozzles, fluidic nozzles, and/or the like, and/or combinations thereof.

Referring now to FIG. 1 B, an alternate embodiment of a die set 12 and mold cavity 14 is depicted, showing an alternate configuration of the two cores 20, 22. The method for forming the fluid nozzle assembly 10 is similar to that described above, however, instead of molding nozzle 28 with the cores 20, 22, a bore 29 is defined within fluid nozzle assembly 10. In this embodiment, parting line/plane 34 is advantageously at an end of the assembly 10, similar to parting line/plane 36. As such, it may be a relatively simple matter to substantially prevent flash at line 34 in this embodiment through the optimization of process parameters discussed above in relation to line 36. The bore 29 is adapted to receive any suitable nozzle 28. In one non-limitative embodiment, a nozzle member 28′ may be received therein.

One example of a nozzle member 28′ is schematically shown in FIG. 1C, which also depicts a spray characteristic of a fluidic nozzle. In this embodiment of nozzle member 28′, fluid tends to flow close to an adjacent wall of the nozzle. When this occurs, the pressure along the opposite wall is lowered, causing the flow to go towards the opposite wall. This change in pressure continues, causing flow substantially similar to that depicted by the directional flow arrows in the Figure.

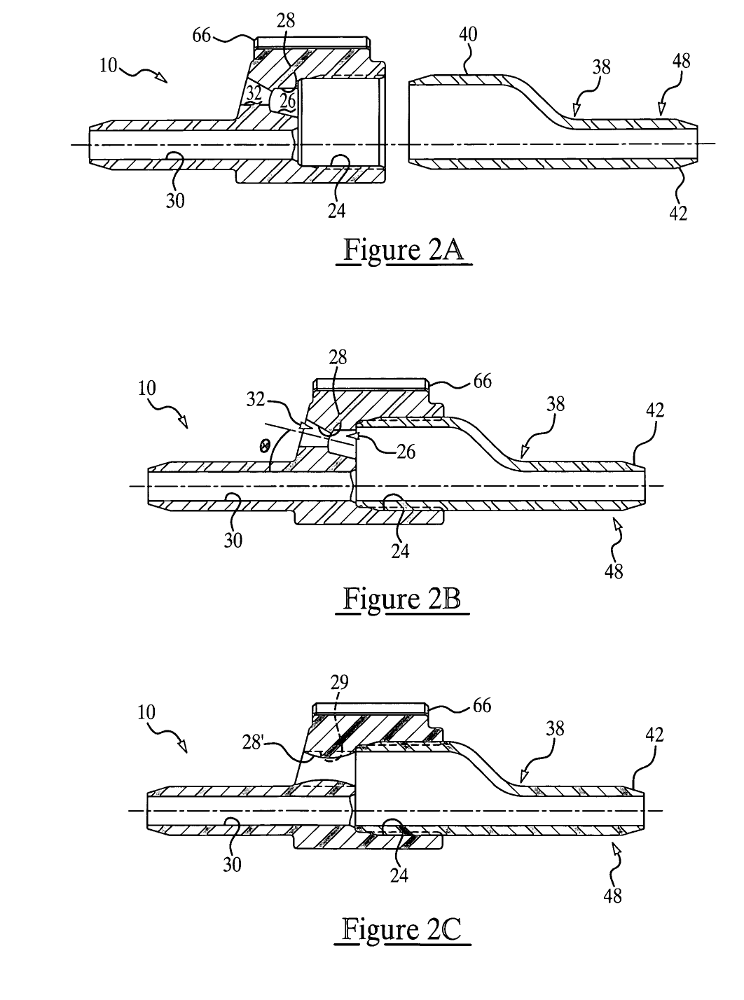

Referring now to FIGS. 2A and 2B together, in an embodiment, the nozzle 28 may be offset by an angle θ from the pass-through conduit 30. It is to be understood that the nozzle 28, 28′ may be offset by any suitable angle (including zero), as desired. In an embodiment, the angle θ may range from about −45° to about 45°; and in an alternate embodiment, the angle θ may range from about −30° to about 30°. In the embodiment shown in FIG. 2B, the angle θ is about 30°.

It is to be understood that the fluid nozzle assembly 10 may be any suitable fluid nozzle assembly, as desired. In the example embodiment shown in FIGS. 2A and 2B, the nozzle assembly 10 is a pass-through nozzle assembly. It is to be further understood that the pass-through nozzle assembly may be for any suitable end use/application, as desired, one non-limitative example of which is a vehicle washer system (e.g. a surface washing system such as windshield washers, headlight washers, and/or the like).

The embodiment shown in FIG. 2C depicts a pass-through nozzle assembly 10 formed by the method depicted in FIG. 1B and having a nozzle member 28′ (FIG. 1C) received therein.

The fluid nozzle assembly 10 formed by the method disclosed herein advantageously includes the pass-through conduit 30 and nozzle 28 having therein substantially no undesirable residual flash (and any relatively small amounts of flash that may be present may be efficiently removed and/or prevented, as described above) from the molding process forming the nozzle assembly 10.

Fluid nozzle assembly 10 may have engaged therewith a fluid connector 38 having a bore-engaging end portion 40 and an end portion 42 distal thereto. The bore-engaging end portion 40 is sealingly engageable (as shown in FIG. 2B) with the fluid connector receiving bore 24, and the distal end portion 42 is adapted to sealingly engage with an end 46 of a fluid supply conduit 44 (shown in FIG. 8).

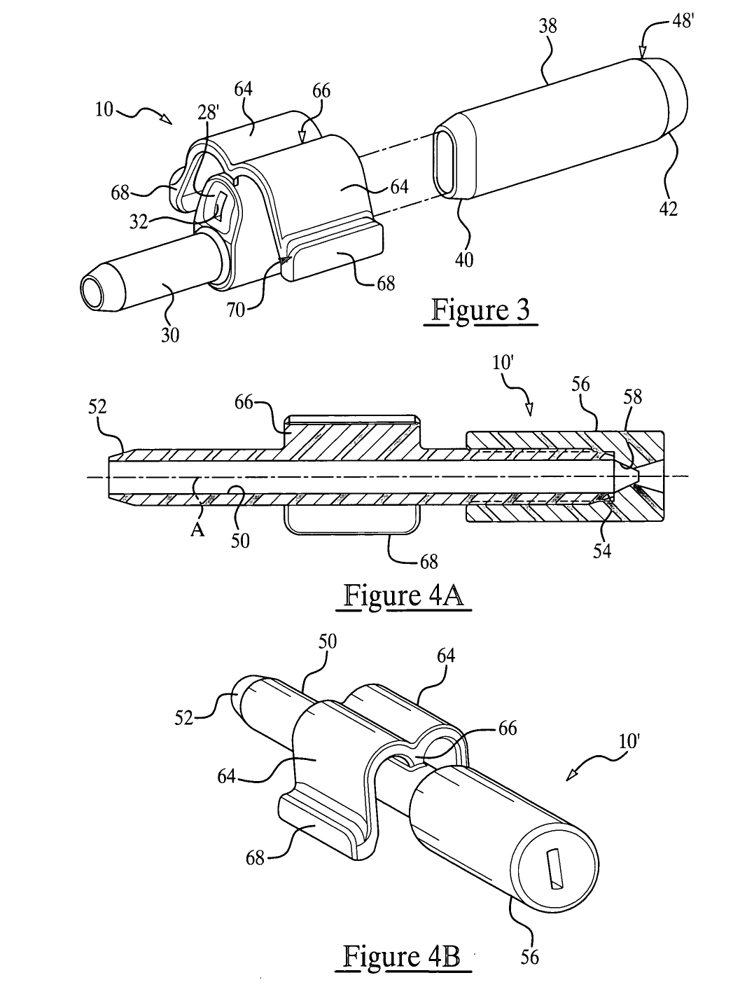

Referring now to FIG. 3, the nozzle assembly 10 is also advantageous in that it 10 is adapted to have different fluid connectors 38 engaged therewith. The distal end portion 42 of the fluid connector 38 has a connecting surface 48 (FIG. 2A), 48′ (FIG. 3) complementarily sized and shaped to the end 46 of the fluid supply conduit 44. Fluid connector 38 as disclosed herein advantageously may obviate the need to redesign and tool a new nozzle assembly 10 to accommodate varied fluid supply conduits 44. FIG. 3 depicts an example embodiment of a connecting surface 48′ adapted to accommodate a larger diameter fluid supply conduit 44 than that 48 of FIG. 2A. FIG. 3 also shows an outer view of an example of a nozzle member 28′ received within the fluid nozzle assembly 10 formed by the method of FIG. 1 B.

Although one nozzle 28, 28′ is shown in the various figures in a single nozzle assembly 10, 10′, it is contemplated as being within the purview of the present disclosure to include more than one nozzle 28, 28′ within a single nozzle assembly 10, 10′, as desired and/or as suitable for a particular application and/or to achieve desired spray characteristics.

It is to be understood that the sealing engagement of the various components 10, 10′, 38, 44, etc. as disclosed herein is substantially fluid-tight, and that such sealing engagement may be accomplished by any suitable fastening means. In an embodiment, this fastening means includes, but is not limited to at least one of press-fit, snap fit, threads, adhesives, welding, and/or the like, and/or combinations thereof.

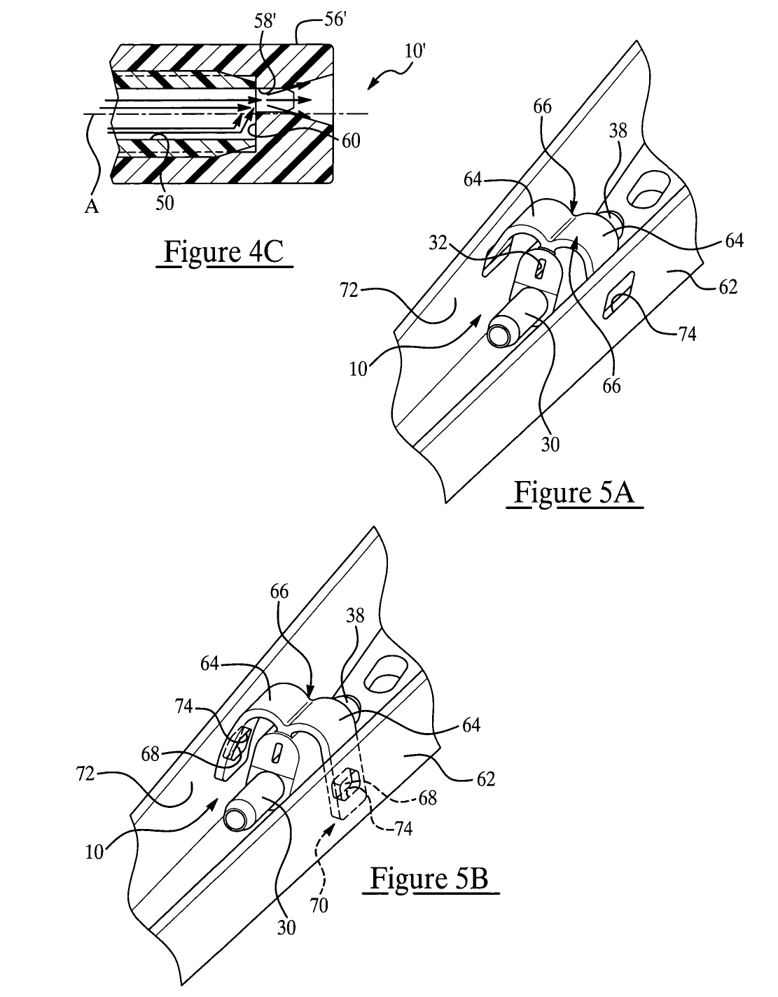

An alternate embodiment of the fluid nozzle assembly is depicted generally as 10′ in FIGS. 4A-4C. The fluid nozzle assembly 10′ includes a fluid conduit 50 having opposed ends 52, 54 and having therein substantially no residual flash from a molding process forming the nozzle assembly 10′. In this embodiment, the die for forming the conduit 50 would include a single core (not shown) adapted to be removed from one of the two ends 52, 54 toward the other of the two ends 54, 52. In this manner, undesirable flash within conduit 50 would be minimized, if not substantially eliminated, as discussed hereinabove in relation to pass-through conduit 30.

Nozzle assembly 10′ further includes one of the opposed ends 52, 54 of conduit 50 adapted to sealingly engage with an end 46 of a fluid supply conduit 44. A nozzle member 56 (for example, an end nozzle) is sealingly engageable with the other of the opposed ends 54, 52 of the fluid conduit 50, and in fluid communication therewith.

This embodiment of nozzle assembly 10′ is advantageous in that various types of nozzle members 56 may be engaged therewith, as desired, while substantially obviating the need to provide various fluid conduits 50. One embodiment of the nozzle member 56 is shown in FIG. 4A wherein the fluid conduit 50 has a center axis A extending longitudinally therethrough. The nozzle member 56 has an inlet 58 in fluid communication with the fluid conduit 50, and substantially concentric with the center axis A.

In an alternate embodiment as shown in FIG. 4C, nozzle member 56′ has an inlet 58′ in fluid communication with the fluid conduit 50, with the inlet 58′ being offset from the center axis A. In this embodiment, the fluid flow through conduit 50 (as depicted by the arrows therein) is disrupted by a sharp shear edge 60. As the fluid flows through conduit 50 from end 52 (as depicted in the figure) toward nozzle inlet 58′, the fluid tends to travel close to the wall to which it is adjacent. When the fluid traveling below center axis A hits sharp shear edge 60 (defined by the offset inlet 58′), that fluid is forced up into the fluid flow above center axis A and collides therewith, disrupting that fluid flow/inducing turbulence therein above center axis A. This changes the spray characteristics exiting nozzle 56′ from a stream spray (as would be the spray from the nozzle 56 embodiment of FIG. 4A) to a fan spray. It is to be understood that there may be two sharp shear edges 60, one above and one below axis A. In this embodiment, the sharp shear edges 60 may be symmetrical or non-symmetrical about axis A.

Referring now to FIGS. 3, 4B, 5A and 5B, there is depicted a system for retaining a fluid nozzle assembly 10, 10′ in a wiper arm 62. The system includes a spring member 64 attached at one end 66 to the nozzle assembly 10, 10′ and adapted to operatively orient the nozzle assembly 10, 10′ with respect to the wiper arm 62. It is to be understood that this operative orientation may position the nozzle assembly 10, 10′ within, on, and/or partially in wiper arm 62, depending upon the design and/or desire of the end user.

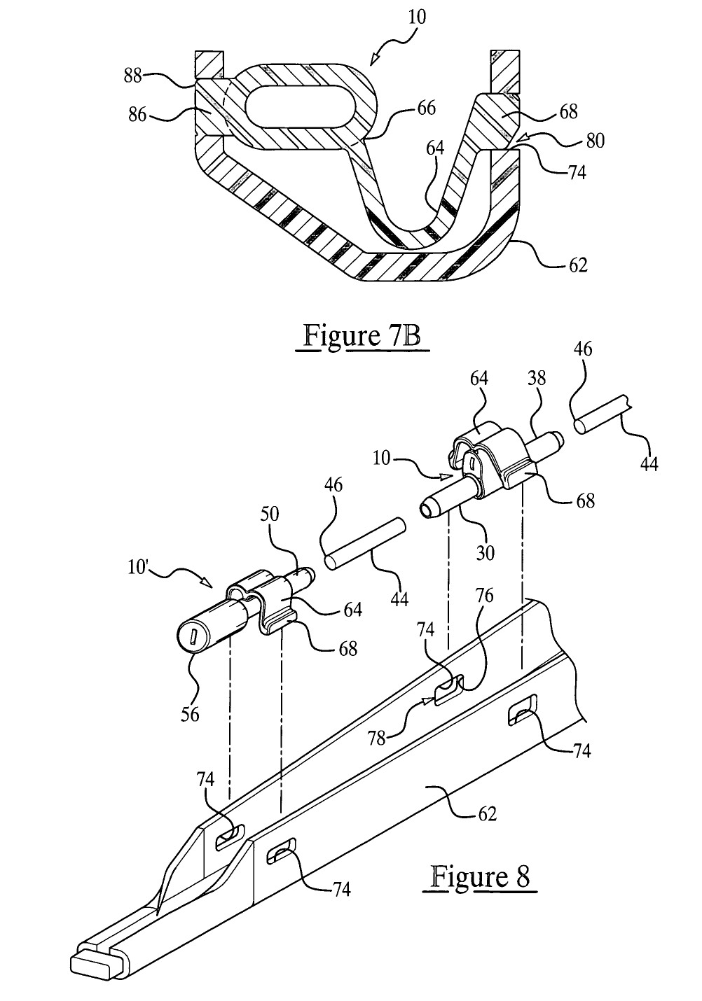

It is to be understood that any number of suitable spring members 64 may be used, as desired. In the embodiments shown in FIGS. 3, 4 etc., two spring members 64 are used. In the embodiment shown in FIGS. 7A and 7B, a single spring member 64 is used. In this embodiment, a tab 86 attached to, or integrally formed with nozzle assembly 10, 10′ may be matingly engaged within a tab-receiving aperture 88 defined within wiper arm 62.

In an embodiment with two spring members 64, the respective one ends 66 of the first and second spring members 64 may be integral with each other and with the nozzle assembly 10, 10′, as best seen in FIGS. 3, 4B, 5A and 5B.

It is to be further understood that the spring member(s) 64 may be formed from the same material as, or a different material from the nozzle assembly 10,10′; and that the spring member(s) 64 may be formed by any suitable process, as desired. Yet further, the spring member(s) 64 may be integrally molded with the nozzle assembly 10, 10′, or may be attached thereto by any suitable means. In the integral attachment embodiment, the end 66 of spring member 64 may act as a living hinge. Further, in any of the disclosed embodiments, spring member 64 may be a dynamic spring which generally resists creep and tends not to overstress. This may advantageously aid in prevention of spring member 64 breakage.

A substantially rectangular projection 68 may be disposed on one of the other end 70 of the spring member 64 and an adjacent inner wall 72 of the wiper arm. A substantially rectangular projection-receiving slot 74 may be defined in the other of the adjacent inner wall 72 of the wiper arm 62 and the other end 70 of the spring member 64. FIG. 5A shows the projection 68 on spring member 64, with the respective slot 74 defined in the adjacent wall 72 of wiper arm 62. FIG. 5B shows the projection 68 attached to the adjacent inner wall 72 of wiper arm 62, with the respective slot 74 defined in the other end 70 of spring member 64. The slot 74 has a projection receiving side 76 (best seen in FIG. 8) and an outer periphery 78 defining the projection receiving side 76.

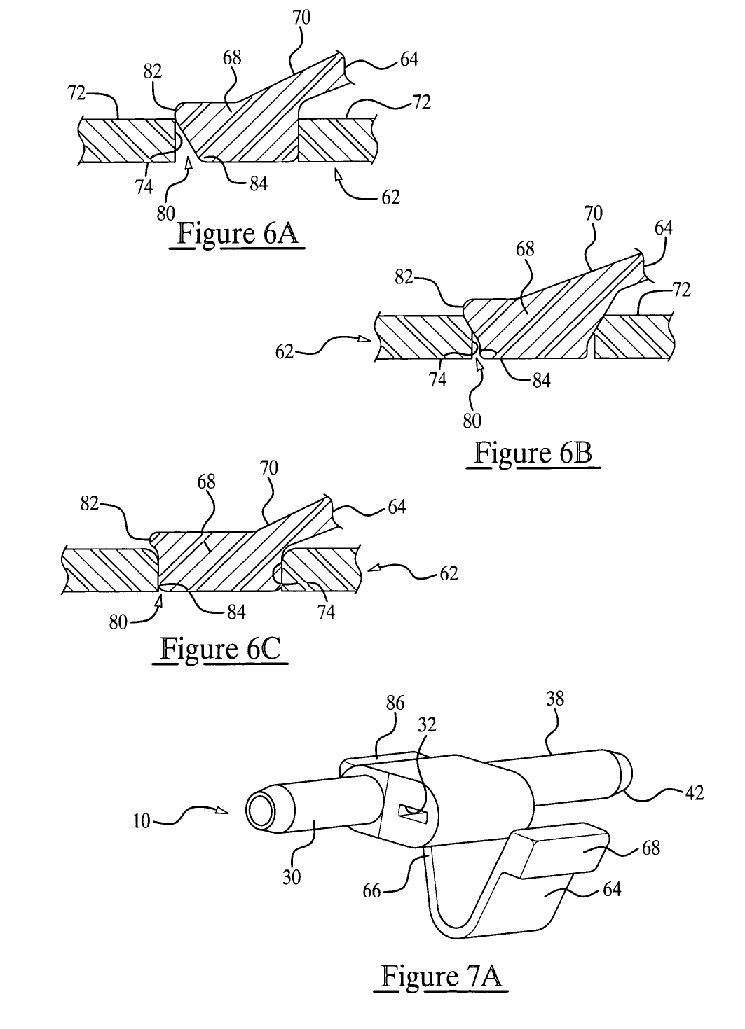

Referring now to FIGS. 6A-6C, in an embodiment, the projection 68 is matingly engageable with the slot 74 so as to retain the assembly 10, 10′ within the wiper arm 62, while leaving a gap 80 between the projection 68 and the slot 74. A portion 82 of the projection 68 distal to a portion 84 of the projection 68 adjacent the gap 80 extends beyond, and is angularly offset from the outer periphery 78. Without being bound to any theory, it is believed that the gap 80, the extending portion 82, or a combination thereof advantageously aids in preventing undesirable rattle or other undesirable vibration(s) when the nozzle assembly 10, 10′ is/are retained with respect to the wiper arm 62. In an example wherein the assembly 10, 10′ is used for a vehicle surface washing system, undesirable rattle/vibrations may occur during use either when the vehicle is in motion or not; or during non-use when the vehicle is in motion.

FIG. 6A shows an embodiment of a substantially wedge-shaped gap 80. It is believed that this embodiment may advantageously contribute to the substantial rattle/vibration prevention mentioned above. Variations of the wedge-shaped gap 80 are depicted in FIGS. 6B and 6C. It is believed that the different projection profiles 82/gaps 80 may provide varying levels of retention force, rattle resistance, and ease of insertion, a particular embodiment of which may be selected as desired and/or as appropriate for a particular application.

It is to be understood that the retaining system(s) described above are non-limitative embodiments, and that any suitable mechanism(s) for retaining the nozzle assemblies 10, 10′ are contemplated as being within the purview of the present disclosure.

Referring now to FIG. 8, there is depicted an exploded view of an embodiment of various components described herein, shown assembled in an embodiment of a wiper arm 62. This embodiment may find particular use for a vehicle windshield wiper washer system. As shown, a fluid nozzle assembly 10′ is sealingly engaged with a fluid supply conduit 44. Upstream from that fluid supply conduit 44 and sealingly engaged therewith at an opposed end is a nozzle assembly 10, fluid connector 38 and second fluid supply conduit 44 (this second fluid supply conduit 44 may be ultimately fluidly connected to a washer fluid reservoir (not shown)). In this embodiment, two spring members 64 are attached to each of nozzle assemblies 10, 10′ and matingly engaged/retained within respective slots 74 defined in wiper arm 62. Although two fluid nozzle assemblies 10, 10′ are shown in the Figure, it is to be understood that any suitable number of nozzle assemblies 10, 10′ may be included, as desired.

The embodiment shown in FIG. 8 may also be advantageous in that it is aesthetically pleasing, with the fluid nozzle assemblies 10, 10′ and associated supply conduits 44 substantially contained within/flush with wiper arm 62.

It is to be understood that any of the embodiments of the various components described herein, e.g. nozzle assembly 10, 10′, the various conduits, retaining systems, etc. may be interchanged within the various embodiments, as desired and/or as appropriate.

While several embodiments have been described in detail, it will be apparent to those skilled in the art that the disclosed embodiments may be modified. Therefore, the foregoing description is to be considered exemplary rather than limiting.

What is claimed is:

1. A method for forming a fluid nozzle assembly, comprising:
providing a die set having a mold cavity therein configured to be a negative replica of the fluid nozzle assembly, the cavity having two cores operatively disposed therein, one of the two cores configured to be a negative replica of: a fluid connector receiving bore; an inlet region of a nozzle in fluid communication with the fluid connector receiving bore; and a pass-through conduit in fluid communication with the fluid connector receiving bore, the other of the two cores configured to be a negative replica of an outlet region of a nozzle in fluid communication with the inlet region;
injecting the mold cavity with a molten polymeric material;
allowing the molten polymeric material to solidify; and
removing the two cores in opposed directions, leaving substantially no flash: at an area where the inlet region and the outlet region meet; and at an end region of the pass-through conduit distal to the fluid connector receiving bore, thereby forming the fluid nozzle assembly.

2. The method as defined in claim 1 wherein the nozzle is angularly offset from the pass-through conduit.

3. The method as defined in claim 1 wherein the fluid nozzle assembly is a pass-through nozzle assembly for a vehicle washer system.

4. The method as defined in claim 3 wherein the pass-through nozzle assembly is adapted to be operatively connected to a wiper arm.

5. A fluid nozzle assembly formed by the method of claim 1.

6. A method for forming a fluid nozzle assembly, comprising:
removing two cores in opposed directions from a die set having a mold cavity therein configured to be a negative replica of the fluid nozzle assembly, the cavity having the two cores operatively disposed therein, one of the two cores configured to be a negative replica of: a fluid connector receiving bore; an inlet region of a nozzle in fluid communication with the fluid connector receiving bore; and a pass-through conduit in fluid communication with the fluid connector receiving bore, the other of the two cores configured to be a negative replica of an outlet region of a nozzle in fluid communication with the inlet region, the removing forming the fluid nozzle assembly after molten polymeric material injected into the mold cavity has solidified, the removing leaving substantially no flash: at an area where the inlet region and the outlet region meet; and at an end region of the pass-through conduit distal to the fluid connector receiving bore.

7. A die set for forming a fluid nozzle assembly, comprising:
a mold cavity defined within the die set, the cavity configured to be a negative replica of the fluid nozzle assembly; and
two cores operatively disposed within the cavity, one of the two cores configured to be a negative replica of: a fluid connector receiving bore; an inlet region of a nozzle in fluid communication with the fluid connector receiving bore; and a pass-through conduit in fluid communication with the fluid connector receiving bore, the other of the two cores configured to be a negative replica of an outlet region of a nozzle in fluid communication with the inlet region.

8. A fluid nozzle assembly, comprising:
a fluid connector receiving bore;
a pass-through conduit in fluid communication with the fluid connector receiving bore, the pass-through conduit having therein substantially no residual flash from a molding process forming the nozzle assembly; and
a nozzle having an inlet region in fluid communication with the fluid connector receiving bore and an outlet region in fluid communication with the inlet region, the nozzle having substantially no residual flash therein.

9. The fluid nozzle assembly as defined in claim 8, further comprising a fluid connector having a bore-engaging end portion and an end portion distal thereto, the bore-engaging end portion sealingly engageable with the fluid connector receiving bore, and the distal end portion adapted to sealingly engage with an end of a fluid supply conduit.

10. The fluid nozzle assembly as defined in claim 8, further comprising at least a second nozzle having an inlet region in fluid communication with the fluid connector receiving bore and an outlet region in fluid communication with the inlet region, the at least a second nozzle having substantially no residual flash therein.

11. The fluid nozzle assembly as defined in claim 8 wherein the nozzle is angularly offset from the pass-through conduit.

12. The fluid nozzle assembly as defined in claim 9 wherein the fluid nozzle assembly is a pass-through nozzle assembly for a vehicle washer system, and wherein the distal end portion of the fluid connector has a connecting surface complementarily sized and shaped to the end of the fluid supply conduit.

13. The fluid nozzle assembly as defined in claim 12 wherein the pass-through nozzle assembly is adapted to be operatively connected to a wiper arm.

14. A fluid nozzle assembly, comprising:
a fluid conduit having opposed ends and having therein substantially no residual flash from a molding process forming the nozzle assembly, one of the opposed ends adapted to sealingly engage with an end of a fluid supply conduit; and
a nozzle member sealingly engageable with the other of the opposed ends of the fluid conduit, and in fluid communication therewith.

15. The fluid nozzle assembly as defined in claim 14 wherein the fluid conduit has a center axis extending longitudinally therethrough, wherein the nozzle member has an inlet in fluid communication with the fluid conduit, the inlet being offset from the center axis.

16. -The fluid nozzle assembly as defined in claim 15 wherein the offset inlet is adapted to induce turbulence in fluid flowing through the fluid conduit, thereby causing a substantial fan spray of fluid exiting the nozzle.

17. A system for retaining a fluid nozzle assembly in a wiper arm, the system comprising:
a spring member attached at one end to the nozzle assembly and adapted to operatively orient the nozzle assembly with respect to the wiper arm;
a substantially rectangular projection disposed on one of an other end of the spring member and an adjacent wall of the wiper arm; and
a substantially rectangular projection-receiving slot defined in the other of the adjacent wall of the wiper arm and the other end of the spring member, the slot having a projection receiving side and an outer periphery defining the projection receiving side;
wherein the projection is matingly engageable with the slot while leaving a gap between the projection and the slot, and wherein a portion of the projection distal to a portion of the projection adjacent the gap extends beyond, and angularly offset from the outer periphery.

18. The system as defined in claim 17 wherein the spring member is integral with the nozzle assembly, and wherein the spring member is a dynamic spring.

19. The system as defined in claim 17, further comprising:
a second spring member attached at one end to the nozzle assembly;
a second substantially rectangular projection disposed on one of an other end of the second spring member and a wall of the wiper arm adjacent the second spring member; and
a second substantially rectangular projection-receiving slot, defined in the other of the wiper arm wall adjacent the second spring member and the other end of the second spring member, the second slot having a second projection receiving side and an outer periphery defining the second projection receiving side;
wherein the second projection is matingly engageable with the second slot while leaving a second gap between the second projection and the second slot, and wherein a portion of the second projection distal to a portion of the second projection adjacent the second gap extends beyond, and angularly offset from the outer periphery of the second slot.

20. The system as defined in claim 19 wherein the respective one ends of the first and second spring members are integral with each other and with the nozzle assembly, and wherein the fluid nozzle assembly comprises:
a fluid connector receiving bore;
a pass-through conduit in fluid communication with the fluid connector receiving bore, the pass-through conduit having therein substantially no residual flash from a molding process forming the nozzle assembly; and
a nozzle having an inlet region in fluid communication with the fluid connector receiving bore and an outlet region in fluid communication with the inlet region, the nozzle having substantially no residual flash therein.

21. The system as defined in claim 19 wherein the respective one ends of the first and second spring members are integral with each other and with the nozzle assembly, and wherein the fluid nozzle assembly comprises:
a fluid conduit having opposed ends and having therein substantially no residual flash from a molding process forming the nozzle assembly, one of the opposed ends adapted to sealingly engage with an end of a fluid supply conduit; and
a nozzle sealingly engageable with the other of the opposed ends of the fluid conduit, and in fluid communication therewith.
